(19) United States
(12) Patent Application Publication
(10) Pub. No.: US 2026/0170454 A1
(43) Pub. Date: Jun. 18, 2026

(54) INFORMATION PROCESSING APPARATUS AND INFORMATION PROCESSING METHOD

(71) Applicant: Toshiba Tec Kabushiki Kaisha, Tokyo (JP)

(72) Inventor: Tetsuya ISHIDA, Sunto Shizuoka (JP)

(21) Appl. No.: 19/532,070

(22) Filed: Feb. 6, 2026

Related U.S. Application Data
(63) Continuation of application No. 18/484,875, filed on Oct. 11, 2023.

(30) Foreign Application Priority Data
Jan. 18, 2023 (JP) 2023-005926

(51) Int. Cl. G06Q 10/087

(52) U.S. Cl. CPC G06Q 10/087

(57) ABSTRACT

According to an embodiment, an information processing apparatus acquires stock information indicating a stock status of a product displayed on a sales floor. The information processing apparatus selects, on the basis of the acquired stock information, a product in short supply that needs to be replenished to the sales floor. Further, the information processing apparatus sets, where the product in short supply includes a plurality of products, priority of replenishment to the sales floor for the selected product in short supply.

### CROSS-REFERENCE TO RELATED APPLICATIONS

This application is a continuation of U.S. patent application Ser. No. 18/484,875, filed on Oct. 11, 2023, which is based upon and claims the benefit of priority from the prior Japanese Patent Application No. 2023-005926, filed on Jan. 18, 2023, the entire contents of each of which are incorporated herein by reference.

### FIELD

An embodiment to be described here generally relates to an information processing apparatus, an information processing method, and a stocking information notification system.

### BACKGROUND

Stores such as supermarkets prevent the loss of sales opportunities by replenishing a product when the product displayed on the sales floor runs out or the number of products is reduced. Note that in the following description, a situation in which a product displayed on the sales floor runs out or the number of products is reduced to need replenishment is referred to also as “in short supply” and a product that is in short supply is referred to also as a “product in short supply”. Further, replenishing the sales floor with the product in short supply is referred to also as “stocking”.

In the past, a product management system that detects the short supply of a product on a display shelf displaying products on the basis of an image of a sales floor and notifies a sales clerk of the product in short supply has been proposed. According to this existing technology, the sales clerk can recognize the product in short supply in response to the notification from the product management system and perform stocking.

However, in the existing technology, in the case where there is a plurality of products in short supply, the order of stocking the product in short supply is left to the discretion of individual sales clerks. For this reason, stores have experienced situations in which replenishment of the product in short supply whose opportunity loss is large in the case of being not sold is delayed, for example. As a result, the existing technology still leaves room for improvement in terms of contribution to store profits.

### BRIEF DESCRIPTION OF THE DRAWINGS

FIG. 1 is a schematic diagram showing a stocking notification system that includes an information processing apparatus according to a first embodiment.

FIG. 2 is a diagram showing a sales floor of a store adopting the stocking notification system according to the first embodiment.

FIG. 3 is a block diagram showing a hardware configuration of a store server according to the first embodiment.

FIG. 4 is a diagram showing a data configuration of a product master stored in a storage unit of the store server according to the first embodiment.

FIG. 5 is a diagram showing a data configuration of a transaction information management table stored in the storage unit of the store server according to the first embodiment.

FIG. 6 is a diagram showing a data configuration of a stocking information management table stored in the storage unit of the store server according to the first embodiment.

FIG. 7 is a block diagram showing a functional configuration of a control unit of the store server according to the first embodiment.

FIG. 8 is a block diagram showing a hardware configuration of a sales clerk terminal according to the first embodiment.

FIG. 9 is a block diagram showing a functional configuration of a control unit of the sales clerk terminal according to the first embodiment.

FIG. 10 is a flowchart showing a flow of stocking information notification processing performed by the control unit of the store server according to the first embodiment.

FIG. 11 is a diagram showing stocking information notification screen displayed on a display unit of the sales clerk terminal according to the first embodiment.

FIG. 12 is a diagram showing a data configuration of a stocking information management table according to a second embodiment.

FIG. 13 is a flowchart showing a flow of stocking information notification processing according to the second embodiment.

FIG. 14 is a diagram showing a stocking information notification screen according to the second embodiment.

FIG. 15 is a diagram showing a data configuration of a stocking information management table according to a third embodiment.

FIG. 16 is a flowchart showing a flow of stocking information notification processing according to the third embodiment.

FIG. 17 is a diagram showing a stocking information notification screen according to the third embodiment.

FIG. 18 is a diagram showing another example of the stocking information notification screen according to the third embodiment.

### DETAILED DESCRIPTION

According to an embodiment, an information processing apparatus includes: an acquisition device; a storage device; and a controller. The acquisition device acquires a stock status of a product displayed on a sales floor. The storage device holds a stocking information management table in which a product in short supply that needs to be replenished to the sales floor and priority of replenishment to the sales floor of the product in short supply are stored in association with each other. The controller is configured to acquire, on the basis of the stock status of the product acquired by the acquisition device, stock information indicating the stock status of the product displayed on the sales floor. The controller is further configured to select, on the basis of the acquired stock information, a product in short supply that needs to be replenished to the sales floor. The controller is further configured to set, where the product in short supply includes a plurality of products, priority of replenishment to the sales floor for the selected product in short supply. The controller is further configured to store product specification information and the set priority in the stocking information management table, the product specification information being for specifying the selected product in short supply. The controller is further configured to output stocking information in which the product specification information for specifying the selected product in short supply and the set priority, which are stored in the stocking information management table, are associated with each other.

An information processing apparatus, an information processing method, a program, and a stocking information notification system according to an embodiment will be described below with reference to the drawings. Note that in the drawings, the same reference symbols denote the same or similar portions. The embodiment is not limited by the following description. For example, although an example in which the information processing apparatus is used as a store server managed by a store will be described in the embodiment described below, the present technology is not limited thereto. The information processing apparatus may be a server apparatus managed by a company that provides stocking information notification service to a store. Further, the store server and the server apparatus may each include a plurality of computers.

Further, although the store server selects a product in short supply on the basis of imaging data obtained by imaging a sales floor by a camera installed in a shopping cart in the embodiment described below, the present technology is not limited thereto. The store server may select a product in short supply on the basis of imaging data obtained by imaging a sales floor by a camera fixed in the sales floor.

Further, the store server may select a product in short supply on the basis of the output of a weight sensor installed in a display shelf for displaying products. In this case, for example, the store server selects, in the case where the weight detected by the weight sensor installed in the display shelf is a predetermined value or less, the product placed on the display shelf as a product in short supply. Further, the store server may select a product in short supply on the basis of payment information of an accounting device such as a point-of-sales (POS) terminal. In this case, for example, the store server selects, in the case where the payment information from the accounting device indicates that a predetermined number or more of specific products is sold, the specific product as a product in short supply.

### First Embodiment

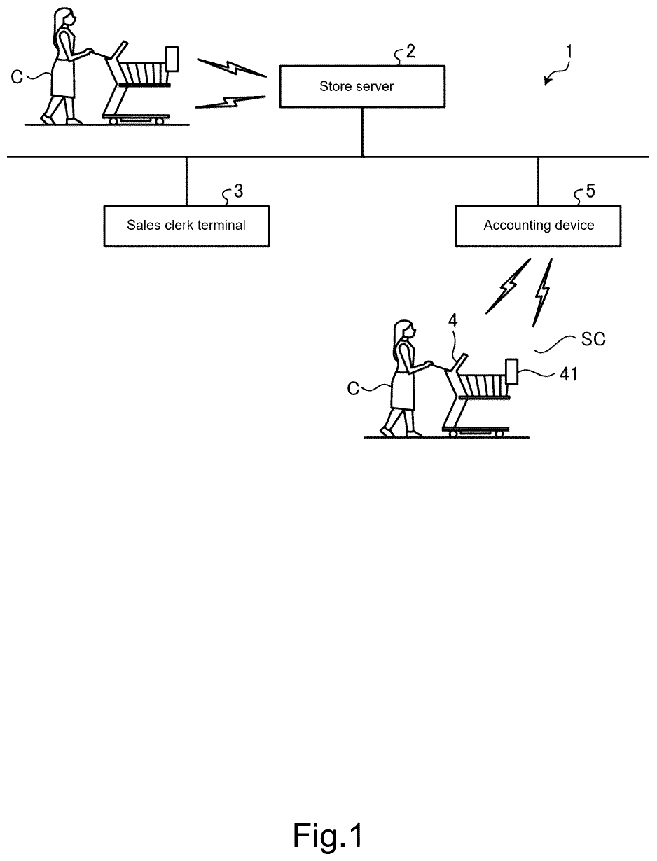

FIG. 1 is a schematic diagram showing a stocking information notification system 1 that includes an information processing apparatus according to a first embodiment. The stocking information notification system 1 according to this embodiment is applied to, for example, a store such as a supermarket. The stocking information notification system 1 includes a store server 2 managed by the store, a sales clerk terminal 3 operated by a sales clerk, a registration terminal 4 installed in a shopping cart SC, and an accounting device 5.

The store server 2, the sales clerk terminal 3, the registration terminal 4, and the accounting device 5 are communicably connected to each other via a network such as a wired or wireless local area network (LAN). Note that the numbers of the store servers 2, the sales clerk terminals 3, the registration terminals 4, and the accounting devices 5 are not limited to the illustrated example. The store server 2 is an example of an information processing apparatus and the sales clerk terminal 3 is an example of a terminal device.

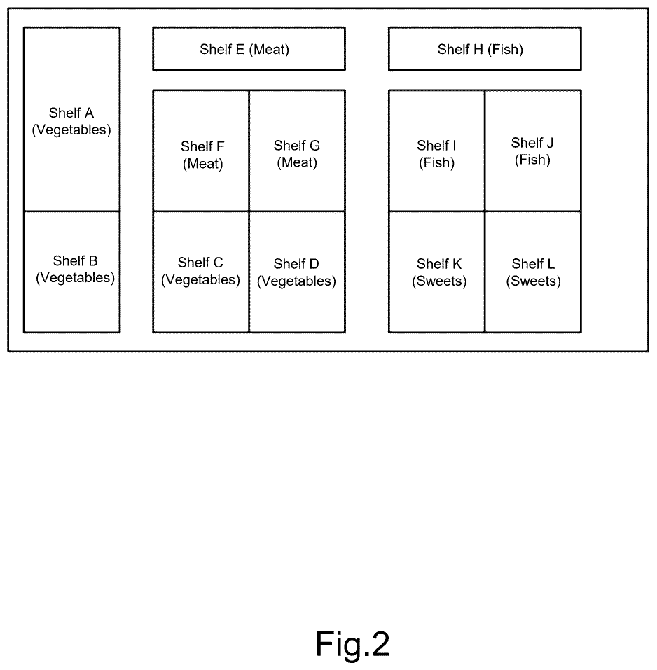

A customer C shops while moving the shopping cart SC in a sales floor. FIG. 2 is a diagram showing an example of the sales floor of the store. In the sales floor, a plurality of display shelves A to L are disposed. The display shelves are divided by product category. Specifically, products whose product category is “vegetables” are displayed on the display shelves A to D. Products whose product category is “meat” are displayed on the display shelves E to G. Products whose product category is “fish” are displayed on the display shelves H to J. Products whose product category is “sweets” are displayed on the display shelves K and L.

The customer C causes the store server 2 to register product information of a product to be purchased (hereinafter, referred to also as a “to-be-purchased product”) by using the registration terminal 4 of the shopping cart SC in the sales floor shown in FIG. 2. For example, the registration terminal 4 reads the product code from the code symbol attached to the to-be-purchased product by a scanner (not shown) in accordance with an operation of the customer C, and transmits the read product code to the store server 2. The store server 2 reads the product information corresponding to the received product code from a product master stored in the store server 2 itself. The store server 2 issues a transaction code and registers, as transaction information, the read product information in association with the transaction code. In this way, the store server 2 manages transaction information for each transaction code.

Note that the product information may be registered in the registration terminal 4. In this case, the registration terminal 4 may read the product information corresponding to the product code from a product master stored in the registration terminal 4 itself or may acquire the product information from the store server 2.

Upon completing the registration of product information for all the to-be-purchased products, the customer C moves to the accounting device 5 and inputs a transaction code. The input of a transaction code is made by, for example, reading the code symbol displayed on the registration terminal 4 by the scanner of the accounting device 5. The accounting device 5 acquires the transaction information corresponding to the input transaction code from the store server 2 and executes account processing for the customer C to make a payment. In this way, the customer C can complete the payment for the to-be-purchased products.

A camera 41 installed in each shopping cart SC images a display shelf in the sales floor while a plurality of customers C moves in the sales floor. The store server 2 is capable of recognizing the state of the display shelves A to L on the entire sales floor by acquiring imaging data obtained by imaging the sales floor by the camera 41 of each of a plurality of shopping carts SC moving in the sales floor. The store server 2 determines whether or not there is a product in short supply from the state of the display shelves A to L recognized on the basis of the acquired imaging data. In other words, the store server 2 detects a product in short supply on the basis of the acquired imaging data. Note that the criteria for determining that the product is in short supply can be arbitrarily set by the store. Further, the store server 2 sets, in the case where there is a plurality of products in short supply, priority of replenishment to the sales floor of the product in short supply, i.e., the stocking priority of the product in short supply.

The setting of the stocking priority (hereinafter, referred to also simply as “priority”) is made on the basis of, for example, the degree of opportunity loss of the product in short supply in the case of being not sold. Note that the method of setting the priority can be arbitrarily set by the store. For example, the store may set higher priority for lots of product in stock.

The store server 2 outputs, to the sales clerk terminal 3, stocking information for notifying a sales clerk of a product in short supply and priority. The sales clerk can recognize which product in short supply should be preferentially stocked by viewing the stocking information acquired by the sales clerk terminal 3. The sales clerk terminal 3 may be, for example, an information terminal carried by the sales clerk, which is disposed in the sales floor, or a personal computer (PC) that is installed in the backyard and operated by the sales clerk.

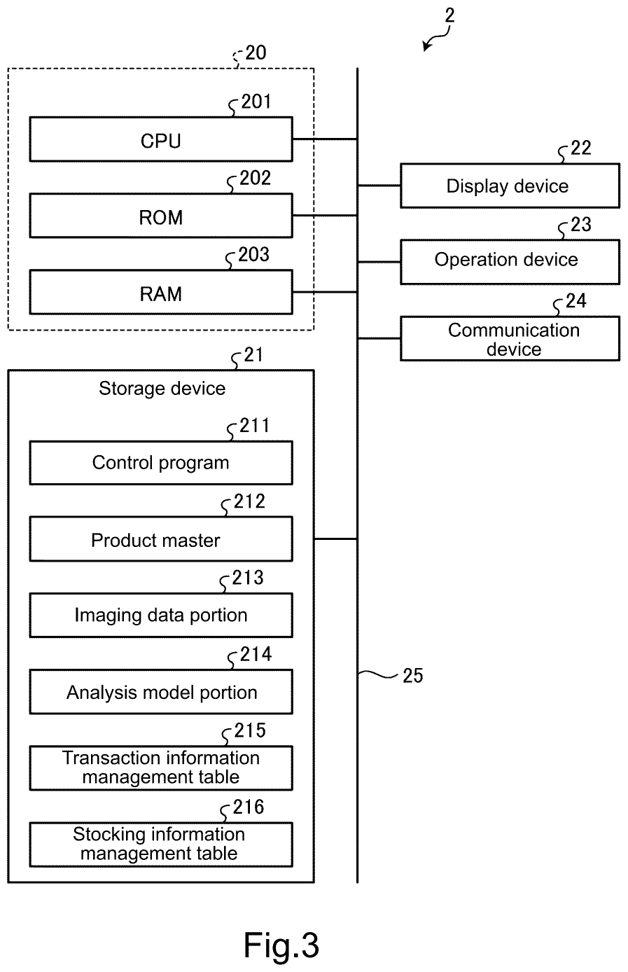

Next, each device will be described. First, the store server 2 will be described. FIG. 3 is a block diagram showing a hardware configuration of the store server 2. The store server 2 includes a controller 20, a storage device 21, a display device 22, an operation device 23, and a communication device 24. The controller 20, the storage device 21, the display device 22, the operation device 23, and the communication device 24 are connected to each other via a bus 25 or the like.

The controller 20 includes a computer including a processor 201, a read only memory (ROM) 202, and a random access memory (RAM) 203. The processor 201 is, for example, a central processing unit (CPU). Hereinafter, the processor 201 will be referred to as the CPU 201. The CPU 201, the ROM 202, and the RAM 203 are connected to each other via the bus 25.

The CPU 201 controls the operation of the entire store server 2. The ROM 202 stores various programs such as a program to be used for driving the CPU 201, and various types of data. The RAM 203 is used as a work area of the CPU 201. The various programs and the various types of data stored in the ROM 202 and the storage device 21 are developed into the RAM 203. The controller 20 executes various types of control processing of the store server 2 when the CPU 201 operates in accordance with the control program that is stored in the ROM 202 and the storage device 21 and developed into the RAM 203.

The storage device 21 includes a storage medium such as a hard disk drive (HDD) and a flash memory, and retains the stored content even if power is cut off. The storage device 21 stores a control program 211, a product master 212, an imaging data portion 213, an analysis model portion 214, a transaction information management table 215, and a stocking information management table 216.

The control program 211 is a program for realizing, for example, a function of registering transaction information on the basis of the product code acquired from the registration terminal 4, a function of acquiring imaging data from the camera 41 installed in the shopping cart SC, a function of selecting a product in short supply on the basis of the acquired imaging data, a function of setting priority of the selected product in short supply, and a function of outputting stocking information in which a product in short supply and priority are associated with each other.

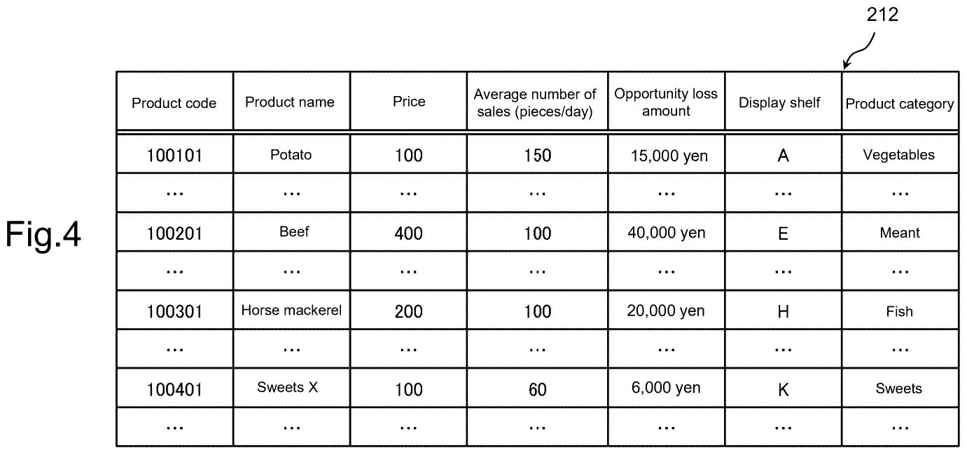

The product master 212 is a master file for storing product information of products handled in the store. Since the products handled in the store change daily, the product master 212 is appropriately updated by the store. FIG. 4 is a diagram showing a data configuration of the product master 212. The product master 212 stores a product name, a price, an average number of sales, an opportunity loss amount, a display shelf, and a product category in association with a product code.

The product code is information for specifying a product, which is an example of the product specification information. The product name is information indicating the name of the product. The price is information indicating the unit price of the product. The average number of sales is information indicating an average number of sales per day. The average number of sales is, for example, information indicating an average number of sales per day in the previous month and is updated every month.

The opportunity loss amount is information indicating the amount calculated by multiplying the corresponding price and the average number of sales. The opportunity loss amount is for estimating the amount of loss due to a failure of selling of a product that could have been sold, which is an example of the degree of opportunity loss determined for each product. Note that the degree of opportunity loss may be, for example, only the price of the product, only the average number of sales per day, or the profit margin of the product. The display shelf is information for specifying the display shelf for displaying products, which is an example of display portion specification information. The product category is information indicating the product category for classifying products, which is an example of classification specification information.

The imaging data portion 213 sequentially stores the imaging data acquired from the camera 41 of each shopping cart SC at predetermined time intervals. The imaging data stored in the imaging data portion 213 is associated with the imaging time. The controller 20 is capable of recognizing, by combining the imaging data of the specific time stored in the imaging data portion 213, the state of all the display shelves in the sales floor at the specific time, i.e., the display state of products on all the display shelves. The imaging data stored in the imaging data portion 213 is an example of stock information indicating a stock status of a product displayed on a sales floor.

The analysis model portion 214 stores an analysis model. The analysis model is a model for data analysis, which is capable of estimating the short supply of a product displayed on a display shelf on the basis of the imaging data obtained by imaging the sales floor. For example, the analysis model may be a machine learning model or an algorithm using no machine learning.

In the former case, for example, the analysis model may be a machine learning model generated by machine learning such as deep learning using teaching data that includes a pair of imaging data obtained by imaging a display shelf in various states and correct answer data indicating the short supply of a product. In the latter case, for example, the analysis model may estimate the short supply of a product displayed on a display shelf on the basis of imaging data obtained by imaging the sales floor using a well-known image processing technology. The analysis model receives imaging data obtained by imaging the sales floor as an input and outputs information indicating a product in short supply estimated on the basis of the imaging data.

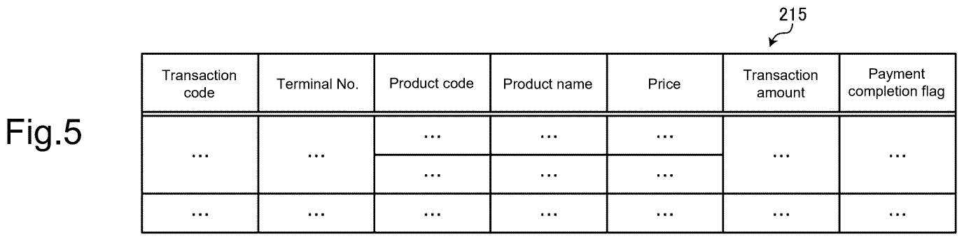

The transaction information management table 215 is a data table for managing transaction information of the customer C for each transaction. The transaction information is information to be used when the accounting device 5 executes account processing. The transaction information management table 215 is appropriately updated on the basis of the information from the registration terminal 4 and the accounting device 5. FIG. 5 is a diagram showing a data configuration of the transaction information management table 215. The transaction information management table 215 stores a terminal No., a product code, a product name, a price, a transaction amount, and a payment completion flag in association with a transaction code.

The transaction code is information for specifying a transaction and is issued by the controller 20. The terminal No. Is information for specifying the registration terminal 4. The product code, the product name, and the price are as described above in the description of the product master 212. In the case where a plurality of products is purchased in one transaction, a plurality of product codes, product names, and prices are registered corresponding to the one transaction code. The transaction amount is information indicating the total amount in the one transaction. The payment completion flag is information indicating whether or not the customer C has completed the payment of the transaction amount. As the payment completion flag, “0” is registered in the case where the payment of the transaction amount by the customer C has not been completed and “1” is registered when the payment has been completed.

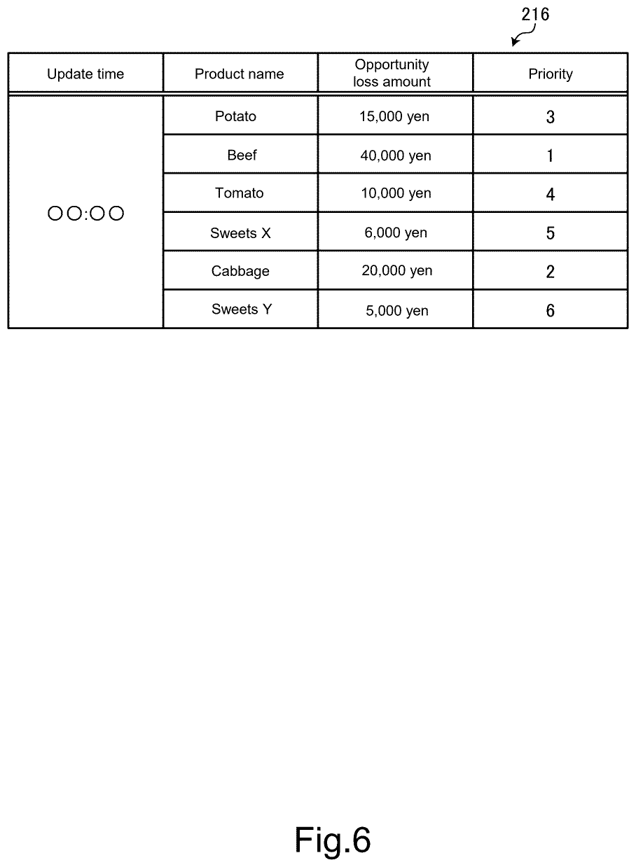

The stocking information management table 216 is a data table for managing stocking information to be notified to the sales clerk terminal 3. The stocking information includes information for specifying a product in short supply such as a product name and a product code, and stocking priority of the product in short supply. The stocking information management table 216 is appropriately updated by the controller 20. For example, the stocking information management table 216 is updated every time the controller 20 executes the stocking information notification processing described below. In the stocking information management table 216, information may be overwritten or accumulated every time a product in short supply is selected by the stocking information notification processing described above. FIG. 6 is a diagram showing a data configuration of the stocking information management table 216. The stocking information management table 216 stores update time, a product name, an opportunity loss amount, and priority in association with each other.

The update time is information indicating the time when the stocking information management table 216 was updated by the controller 20. The product name is information indicating the name of the product determined as being in short supply by the controller 20. In other words, the product name is information indicating the name of the product determined as a product in short supply by the controller 20. The opportunity loss amount is information indicating the opportunity loss amount associated with each product in the product master 212. The priority is information indicating the priority set by the controller 20. Note that the stocking information management table 216 does not necessarily need to store the opportunity loss amount.

In the case where the stocking information management table 216 stores stocking information, the store server 2 periodically transmits the stocking information to the sales clerk terminal 3. Note that in the case where the stocking information management table 216 stores stocking information, the store server 2 may transmits the stocking information to the sales clerk terminal 3 in accordance with a request from the sales clerk terminal 3.

With reference to FIG. 3 again, the hardware configuration of the store server 2 will be described.

The display device 22 includes, for example, a liquid crystal panel, and displays various types of information. The display device 22 displays, for example, information stored in the product master 212, the transaction information management table 215, the stocking information management table 216, or the like as necessary.

The operation device 23 is for inputting information to the controller 20, and includes a keyboard, a touch panel, a mouse, and the like.

The communication device 24 is an interface for communicating with an external device such as the sales clerk terminal 3, the registration terminal 4, and the accounting device 5. The controller 20 is capable of transmitting/receiving information (data) to/from the external device by being connected to the external device via the communication device 24.

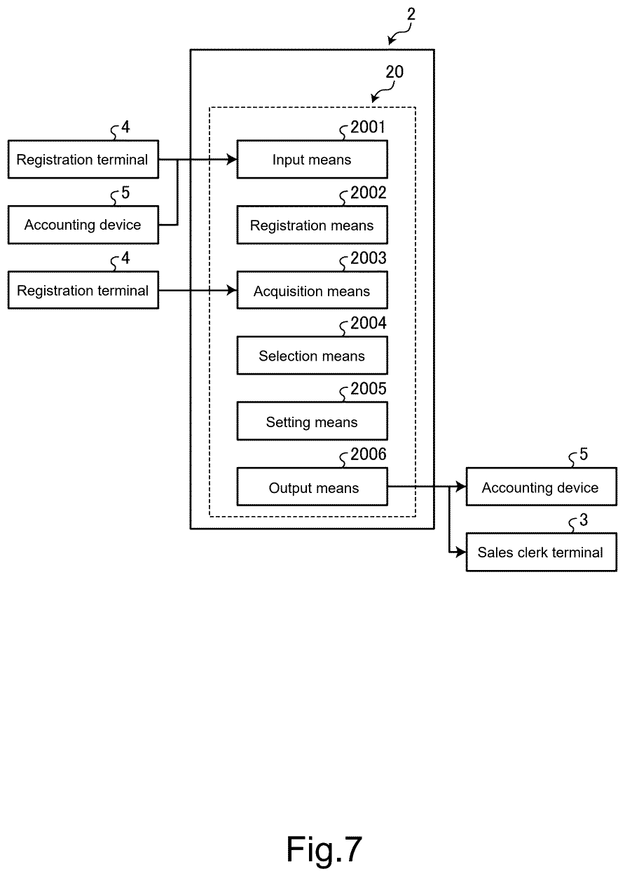

Subsequently, a functional configuration of the store server 2 will be described. FIG. 7 is a block diagram showing a main functional configuration of the controller 20 of the store server 2. The controller 20 functions as an input means 2001, a registration means 2002, an acquisition means 2003, a selection means 2004, a setting means 2005, and an output means 2006 when the CPU 201 operates in accordance with the program stored in the ROM 202 and the storage device 21. Note that these functions may be formed by hardware such as a dedicated circuit or the like.

The input means 2001 inputs various types of information from an external device. For example, the input means 2001 inputs a product code from the registration terminal 4. Further, the input means 2001 inputs a transaction information request from the accounting device 5. The transaction information request is a request for transaction information that is necessary for the accounting device 5 to execute account processing and includes a transaction code for specifying transaction information.

Note that the input means 2001 may input replenishment completion information from the sales clerk terminal 3. The replenishment completion information is information indicating that a sales clerk has stocked a product in short supply, and includes a product code of the stocked product in short supply. In this case, the controller 20 updates the stocking information management table 216 when replenishment completion information is input to the input means 2001. Specifically, the controller 20 deletes, from the stocking information management table 216, the product of the product code included in the replenishment completion information.

The registration means 2002 executes product registration. Specifically, the registration means 2002 reads, from the product master 212, the product information corresponding to the product code input to the input means 2001, and registers necessary information in the transaction information management table 215. The registration means 2002 issues a transaction code when the first product code in one transaction is input to the input means 2001, and registers product information in association with the transaction code. At this time, the registration means 2002 registers “0” in the corresponding payment completion flag.

The acquisition means 2003 acquires stock information indicating a stock status of a product displayed on a sales floor using the acquisition device. Specifically, the acquisition means 2003 acquires, from the registration terminal 4, imaging data that is an example of stock information at predetermined intervals. The imaging data acquired by the acquisition means 2003 is imaging data obtained at any time by the camera 41 installed in the shopping cart SC moving in the sales floor, and is associated with the imaging time. An example of the transaction device in this case is the camera 41 that outputs imaging data. The acquisition means 2003 stores the acquired imaging data in the imaging data portion 213 of the storage device 21.

Note that the acquisition means 2003 may acquire other information as stock information. For example, the acquisition means 2003 may acquire weight data from a weight sensor that detects the weight of a product displayed on a display shelf. An example of the transaction device in this case is a weight sensor. Further, the acquisition means 2003 may acquire transaction information from the accounting device 5. An example of the transaction device in this case is the accounting device 5.

The selection means 2004 selects, on the basis of the stock information acquired by the acquisition means 2003, a product in short supply that needs to be replenished to a sales floor. Specifically, the selection means 2004 selects a product in short supply from the imaging data acquired by the acquisition means 2003 using the analysis model stored in the analysis model portion 214 of the storage device 21. In other words, the selection means 2004 selects a product in short supply that is not on a display shelf or in low quantities and needs to be replenished, of a plurality of types of products displayed on a display shelf. The selection means 2004 writes information to the stocking information management table 216 upon selecting the product in short supply.

In the case where the selection means 2004 has selected a plurality of products in short supply, the setting means 2005 sets priority of replenishment to the sales floor for the selected product in short supply. Specifically, the setting means 2005 reads, from the product master 212, the opportunity loss amount of the product in short supply selected by the selection means 2004, and sets priority in descending order of the opportunity loss amount. In this embodiment, the setting means 2005 sets priority for each product. The setting means 2005 writes the set priority to the stocking information management table 216.

The output means 2006 outputs various types of information to an external device. For example, the output means 2006 outputs stocking information in which product specification information (product code) for specifying the product in short supply selected by the selection means 2004 and the priority set by the setting means 2005 are associated with each other. Specifically, in the case where a product in short supply has been registered in the stocking information management table 216 when the stocking information management table 216 is updated, the output means 2006 outputs, to the sales clerk terminal 3, stocking information in which the product code and the priority of the product in short supply are associated with each other.

Further, when a transaction information request is input from the accounting device 5 to the input means 2001, the output means 2006 outputs, to the accounting device 5, transaction information corresponding to the transaction code included in the transaction information request.

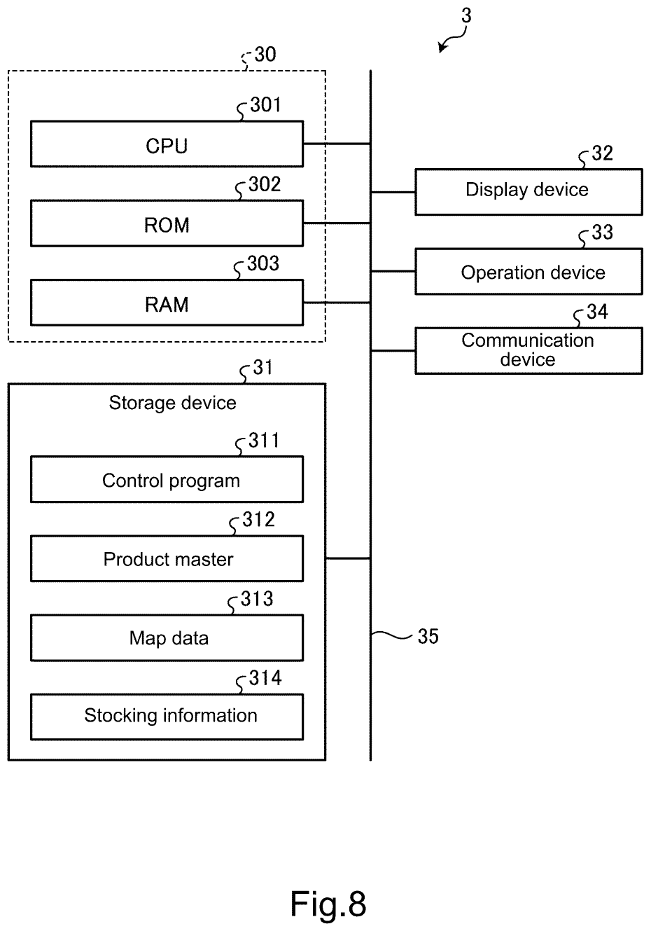

Next, the sales clerk terminal 3 will be described. FIG. 8 is a block diagram showing a hardware configuration of the sales clerk terminal 3. The sales clerk terminal 3 includes a controller 30, a storage device 31, a display device 32, an operation device 33, and a communication device 34. The controller 30, the storage device 31, the display device 32, the operation device 33, and the communication device 34 are connected to each other via a bus 35 or the like.

The controller 30 includes a computer including a processor 301, a ROM 302, and a RAM 303. The processor 301 is, for example, a central processing unit (CPU). Hereinafter, the processor 301 will be referred to as the CPU 301. The CPU 301, the ROM 302, and the RAM 303 are connected to each other via the bus 35.

The CPU 301 controls the operation of the entire sales clerk terminal 3. The ROM 302 stores various programs such as a program used for driving the CPU 301 and various types of data. The RAM 303 is used as a work area of the CPU 301. The CPU 301 develops the various programs and the various types of data stored in the ROM 302 and the storage device 31 into the RAM 303. The controller 30 executes various types of control processing of the sales clerk terminal 3 when the CPU 301 operates in accordance with the control program that is stored in the ROM 302 and the storage device 31 and developed into the RAM 303.

The storage device 31 includes a storage medium such as an HDD and a flash memory, and retains the stored content even if power is cut off. The storage device 31 stores a control program 311, a product master 312, map data 313, and stocking information 314.

The control program 311 is, for example, a program for realizing a function of transmitting/receiving various types of information to/from the store server 2, a function of receiving various types of information from the operation device 33, a function of displaying stocking information on the display device 32, and the like.

The product master 312 is received from the store server 2 and is the same as the product master 212 stored in the store server 2. The map data 313 is information indicating the map of a sales floor. The stocking information 314 is stocking information received from the store server 2. The stocking information 314 is, for example, overwritten every time it is received from the store server 2, and the latest stocking information is stored.

Note that the storage device 31 does not necessarily need to store the product master 312. In this case, the sales clerk terminal 3 is capable of handling the product master 212 by referring to the product master 212 stored in the store server 2, similarly to the configuration of holding the product master 312.

The display device 32 includes, for example, a liquid crystal panel and displays various types of information. Tor example, the display device 22 displays the stocking information received from the store server 2. Details of the display of short-supply information by the display device 22 will be described below.

The operation device 33 is for inputting information to the controller 30 and includes, a keyboard, a touch panel, a mouse, and the like. For example, the operation device 33 inputs, to the controller 30, information instructing to switch the display format of the stocking information.

The communication device 34 is an interface for communicating with an external device such as the store server 2. The controller 30 is capable of transmitting/receiving information (data) to/from the external device by being connected to the external device via the communication device 34.

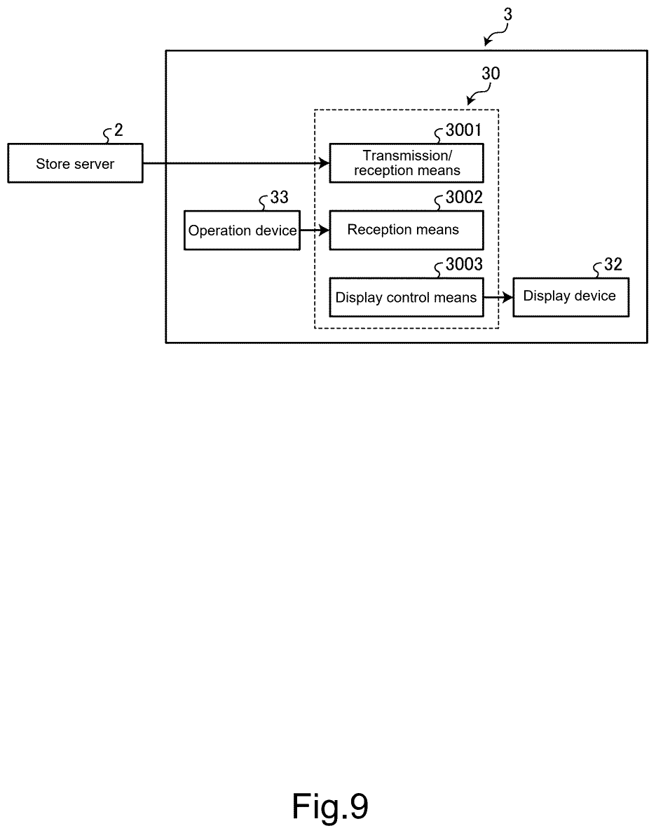

Subsequently, a functional configuration of the sales clerk terminal 3 will be described. FIG. 9 is a block diagram showing a main functional configuration of the controller 30 of the sales clerk terminal 3. The controller 30 functions as a transmission/reception means 3001, a reception means 3002, and a display control means 3003 when the CPU 301 operates in accordance with the control program stored in the ROM 302 and the storage device 31. Note that these functions may be formed by hardware such as a dedicated circuit.

The transmission/reception means 3001 transmits/receives various types of information to/from the store server 2. For example, in the case where the store server 2 has selected a product in short supply, the transmission/reception means 3001 receives stocking information from the store server 2.

The transmission/reception means 3001 may transmit a stocking information request to the store server 2. The stocking information request is for inquiring about the presence or absence of a product in short supply, and is transmitted when a sales clerk operates the operation device 33 as necessary. In other words, the stocking information request is for requesting the store server 2 to detect a product in short supply. The store server 2 performs detection of a product in short supply in accordance with the stocking information request from the sales clerk terminal 3, in addition to the detection of a product in short supply in the stocking information notification processing periodically executed. Then, the store server 2 transmits the stocking information to the sales clerk terminal 3 as necessary.

Further, the transmission/reception means 3001 may transmit replenishment completion information to the store server 2. The replenishment completion information is information indicating that a sales clerk has completed replenishment of a product in short supply, and is transmitted in accordance with an operation of the sales clerk. The store server 2 is capable of updating, by receiving replenishment completion information, the stocking information management table 216 regardless of the stocking information notification processing periodically executed.

The reception means 3002 receives various types of input information from the operation device 33. For example, the reception means 3002 receives a display switch input for switching the display method of stocking information. The reception means 3002 may receive the above-mentioned replenishment completion information.

The display control means 3003 displays various types of information on the display device 32. For example, the display control means 3003 displays, on the display device 32, the stocking information received by the transmission/reception means 3001 from the store server 2. Specifically, the display control means 3003 displays, on the display device 32, the product name, the display area, the stocking priority, and the like of a product in short supply to a sales clerk so that the display area of the product in short supply can be easily understand using the map data 313.

Next, the registration terminal 4 will be described. The registration terminal 4 includes, for example, a tablet terminal. The camera 41 that images a sales floor and a scanner (not shown) that reads a product code from a code symbol attached to a product are connected to the registration terminal 4.

The registration terminal 4 transmits the product code read by the scanner to the store server 2 to cause the store server 2 to register transaction information. Further, the registration terminal 4 transmits the imaging data obtained by imaging by the camera 41 to the store server 2 at any time.

Next, the accounting device 5 will be described. The accounting device 5 is, for example, a so-called self-service accounting device in which the customer C perform an accounting operation by himself/herself. The accounting device 5 acquires the transaction information corresponding to the input transaction code from the store server 2. The accounting device 5 executes, on the basis of the transaction information acquired from the store server 2, account processing relating to the payment by cash payment or cashless payment such as credit card payment. The account processing is processing for the customer C to pay for the products to be purchased.

Note that the accounting device 5 may be a POS terminal that is operated by a sales clerk to register transaction information and execute account processing. In this case, for example, the camera 41 and a transmission device that transmits imaging data of the camera 41 to the store server 2 only need to be provide in the shopping cart SC.

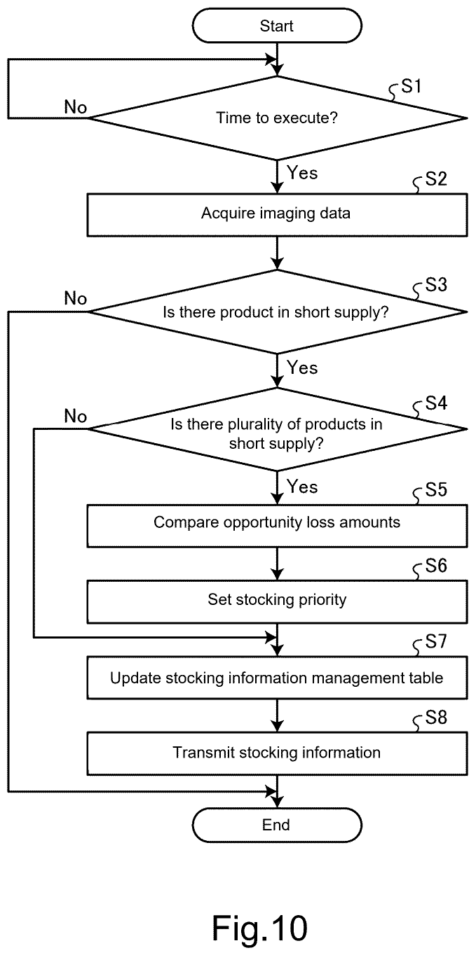

Next, stocking information notification processing executed by the store server 2 will be described. FIG. 10 is a flowchart showing a flow of the stocking information notification processing performed by the controller 20 of the store server 2. The stocking information notification processing is periodically (e.g., every 5 minutes) executed.

In Step 1, the controller 20 whether or not it is time to execute the stocking information notification processing. In the case where it is not time to execute the stocking information notification processing (No in Step S1), the processing of the controller 20 returns to Step S1 and the controller 20 stands by.

In the case where it is time to execute the stocking information notification processing (Yes in Step S1), the processing of the controller 20 proceeds to Step S2. In Step S2, the controller 20 acquires imaging data from the imaging data portion 213 by the selection means 2004. Note that at this time point, the controller 20 may acquire imaging data from the registration terminal 4 by the acquisition means 2003. In this case, the controller 20 immediately acquires, by the selection means 2004, the imaging data acquired by the acquisition means 2003. Subsequently, in Step S3, the controller 20 determines, on the basis of the acquired imaging data, whether or not there is a product in short supply on a sales floor by the selection means 2004. Specifically, the controller 20 determines the presence or absence of a product in short supply by the selection means 2004 using the analysis model stored in the analysis model portion 214.

In the case where there is no product in short supply (No in Step S3), the controller 20 ends the stocking information notification processing. In the case where there is a product in short supply (Yes in Step S3), the processing of the controller 20 proceeds to Step S4. In Step S4, the controller 20 determines whether or not there is a plurality of products in short supply by the selection means 2004.

In the case where there is a plurality of products in short supply (Yes in Step S4), the processing of the controller 20 proceeds to Step S5. In Step S5, the controller 20 reads the opportunity loss amount of the product in short supply from the product master 212 and compares the read opportunity loss amounts with each other by the setting means 2005. Subsequently, in Step S6, the controller 20 sets priority for the product in short supply by the setting means 2005. Specifically, the controller 20 sets priority in descending order of the opportunity loss amount by the setting means 2005.

Subsequently, in Step S7, the controller 20 updates the stocking information management table 216. Specifically, the controller 20 registers, in the stocking information management table 216, information including the update time, the product name of the product in short supply selected by the selection means 2004, and the priority of the product in short supply. Subsequently, in Step S8, the controller 20 transmits, by the output means 2006, stocking information including the product name and the priority, of information registered in the stocking information management table 216, to the sales clerk terminal 3. The controller 20 then ends the stocking information notification processing.

Further, in the case where the product in short supply does not include a plurality of products in Step S4 (No in Step S4), the controller 20 skips Step S5 and Step S6 to proceed Step S7. Note that in this case, since the product in short supply registered in the stocking information management table 216 is singular, “1” is registered as the priority of the product in short supply.

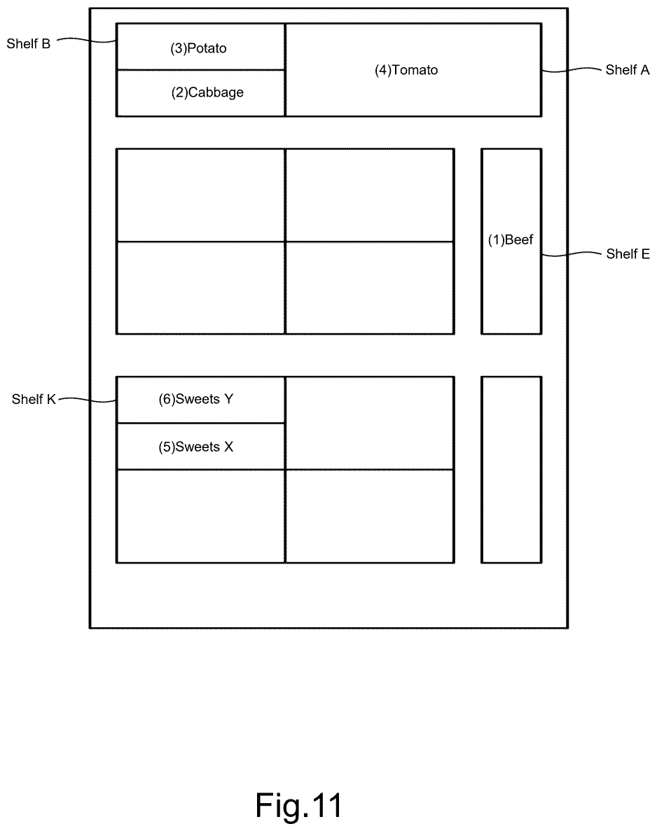

Next, the display of stocking information by the sales clerk terminal 3 will be described. The sales clerk terminal 3 displays a stocking information notification screen on the display device 32 on the basis of the product master 312, the map data 313, and the stocking information 314 stored in the storage device 31. FIG. 11 is a diagram showing a stocking information notification screen displayed on the display device 32 of the sales clerk terminal 3. A stocking information notification screen in the case where the stocking information shown in FIG. 6 is registered in the stocking information management table 216 of the store server 2 will be described here as an example.

As shown in FIG. 11, the display device 32 displays the product name and the priority of the product in short supply in association with the display position of the product in short supply. Specifically, the display device 32 displays a map of the sales floor showing the position of the display shelf and displays the product name and the priority of the product in short supply in association with the display shelf. For example, in the stocking information management table 216 shown in FIG. 6, for the “beef” whose priority is “1”, the display device 32 displays the product name “beef” and the priority “(1)” in association with the display shelf E for displaying the beef.

In more detail, the sales clerk terminal 3 reads, from the product master 312, the display shelf E corresponding to the “beef” included in the stocking information received from the store server 2. The sales clerk terminal 3 then displays, on the display device 32, the product name “beef” and the priority “(1)” of the product in short supply in association with each other at the position of the display shelf E in the map data 313.

Similarly, the display device 32 displays also the product name and the priority of another product in short supply in association with the display position of the product in short supply. Specifically, for the “cabbage” whose priority is “2” and the “potato” whose priority is “3”, the display device 32 displays the product name “cabbage” and the priority “(2)” and the product name “potato” and the priority “(3)” in association with the display shelf B.

Further, for the “tomato” whose priority is “4”, the display device 32 displays the product name “tomato” and the priority “(4)” in association with the display shelf A. Further, for the “sweets X” whose priority is “5” and the “sweets Y” whose priority is “6”, the display device 32 displays the product name “sweets X” and the priority “(5)” and the product name “sweets Y” and the priority “(6)” in association with the display shelf K.

A sales clerk can recognize the product in short supply, the stocking priority of the product in short supply, and the display position of the product in short supply by viewing the stocking information notification screen displayed on the display device 32. The sales clerk can perform stocking in order that is beneficial to the store by recognizing the priority. Further, the sales clerk can efficiently perform stocking by recognizing the display position of the product in short supply.

Note that the display device 32 may indicate the priority by the displayed color instead of or in addition to the display in numbers such as “(1)”. For example, the display device 32 may display the characters or background of the product name of the highest priority product in short supply in red. Further, the stocking information notification screen only needs to display information for specifying a product in short supply and priority, and various display forms can be adopted.

### Second Embodiment

Next, a second embodiment will be described. The second embodiment is different from the first embodiment in that priority of a product in short supply is set in units of a display shelf. Hereinafter, description of the configuration and function similar to those in the first embodiment will be omitted in some cases. This is to avoid unnecessary redundancy in the following description and facilitate understanding by those skilled in the art.

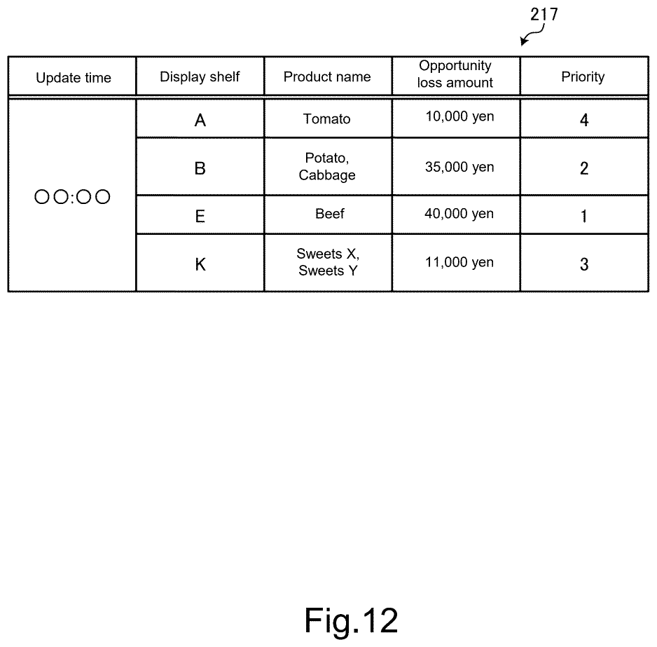

The storage device 21 of the store server 2 includes a stocking information management table 217 shown in FIG. 12. The stocking information management table 217 is a data table for managing a product in short supply for each display shelf. The stocking information management table 217 stores update time, a display shelf, a product name, an opportunity loss amount, and priority in association with each other.

The update time and the product name are similar to those in the first embodiment. The display shelf is information for specifying the display shelf for displaying the product in short supply. In the case where a plurality of products is displayed on one display shelf, a plurality of product names is registered corresponding to the one display shelf. The opportunity loss amount refers to the total opportunity loss amounts of the products in short supply on the corresponding display shelf. In the example shown in FIG. 12, the products in short supply on the display shelf B are the “cabbage” and “potato”. In this case, the opportunity loss amount is 35,000 yen, which is the sum of 20,000 yen of the opportunity loss amount of the “cabbage” and 15,000 yen of the opportunity loss amount of the “potato” in the product master 212. The priority is priority for each display shelf and is set in descending order of the corresponding opportunity loss amount.

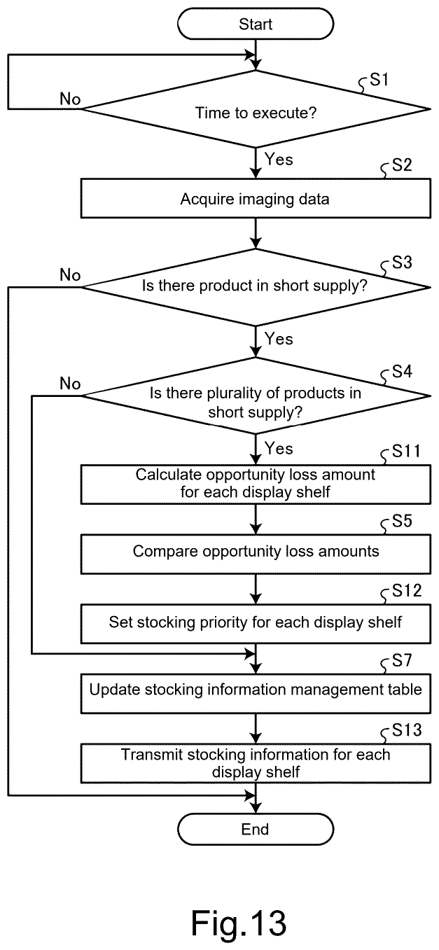

Next, stocking information notification processing executed by the store server 2 will be described. FIG. 13 is a flowchart showing stocking information notification processing performed by the controller 20 of the store server 2 according to the second embodiment.

The processing of Step S1 to Step S4 is similar to that in the first embodiment. In the case where there is a plurality of products in short supply in the processing of Step S4 (Yes in Step S4), the processing of the controller 20 proceeds to Step S11. In Step S11, the controller 20 calculates the opportunity loss amount for each display shelf by the setting means 2005. Specifically, in the case where the product in short supply selected by the selection means 2004 includes a plurality of products on one display shelf, the controller 20 adds, by the setting means 2005, the opportunity loss amounts of the plurality of products in short supply displayed on the display shelf by referring to the product master 212.

Subsequently, in Step S5, the controller 20 compares, by the setting means 2005, the opportunity loss amounts for each display shelf calculated in Step S11 with each other. Subsequently, in Step S12, the controller 20 sets the stocking priority for each display shelf on the basis of the comparison result. Specifically, the controller 20 sets, by the setting means 2005, the priority in units of a display shelf in descending order of the opportunity loss amount.

Subsequently, in Step S7, the controller 20 updates the stocking information management table 217. Subsequently, in Step S13, the controller 20 transmits, by the output means 2006, stocking information for each display shelf to the sales clerk terminal 3. The stocking information for each display shelf includes display portion specification information for specifying the display shelf on which the product in short supply is present, the priority in units of the display shelf, and the product name of the product in short supply. The controller 20 then ends the stocking information notification processing.

Further, in the case where the product in short supply does not include a plurality of products in the processing of Step S4 (No in Step S4), the processing of the controller 20 skips Step S11, Step S5, and Step 12 to proceed to Step S7.

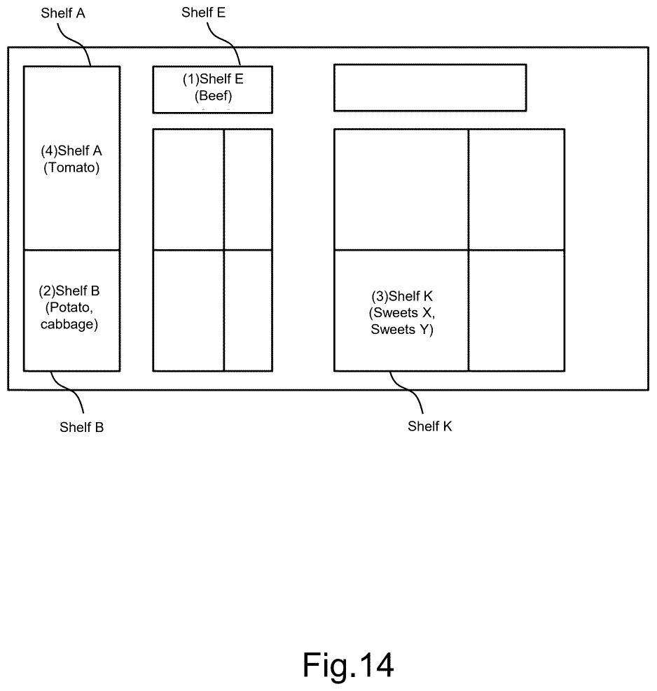

Next, display of stocking information by the sales clerk terminal 3 will be described. FIG. 14 is a diagram showing a stocking information notification screen displayed on the display device 32 of the sales clerk terminal 3 according to the second embodiment. A stocking information notification screen in the case where the stocking information shown in FIG. 12 is registered in the stocking information management table 217 of the store server 2 will be described here as an example.

The display device 32 displays, for a product in short supply, priority for each display shelf, information for specifying the display shelf, and the product name in association with the display shelf. Specifically, the display device 32 displays a map of the sales floor showing the position of the display shelf and displays the priority, the display shelf name, and the product name of the product in short supply in association with the display shelf. For example, the display device 32 displays, for the “beef” that is a product in short supply whose priority is “1” on the display shelf E in the stocking information management table 217 shown in FIG. 12, the display shelf name “shelf E”, the priority “(1)”, and the product name “beef” in association with the display shelf E.

Similarly, the sales clerk terminal 3 displays, also for another product in short supply, the priority for each display shelf, information for specifying the display shelf, and the product name in association with the display shelf. Specifically, the display device 32 displays, for the “potato” and “cabbage” that are products in short supply whose priority is “2” on the display shelf B, the display shelf name “shelf B”, the priority “(2)”, and the product names “potato” and “cabbage” in association with the display shelf B.

Further, the display device 32 displays, for the “sweets X” and “sweets Y” that are products in short supply whose priority is “3” on the display shelf K, the display shelf name “shelf K”, the priority “(3)”, and the product names “sweets X” and “sweets Y” in association with the display shelf K. Further, the display device 32 displays, for the “tomato” that is a product in short supply whose priority is “4” on the display shelf A, the display shelf name “shelf A”, the priority “(4)”, and the product name “tomato” in association with the display shelf A.

A sales clerk can recognize the priority of the display shelf for stocking the product in short supply, i.e., the priority of the product in short supply for each display shelf, by viewing the stocking information notification screen displayed on the display device 32. The sales clerk can perform stocking in order that is beneficial to the store by recognizing the priority, similarly to the first embodiment. Further, since the sales clerk can collectively stock products in short supply for each display shelf, it is possible to efficiently perform the work when stocking products on a display shelf.

### Third Embodiment

Next, a third embodiment will be described. The third embodiment is different from the first embodiment and the second embodiment in that priority of a product in short supply is set in units of a product category. Hereinafter, description of the configuration and function similar to those in the first embodiment and the second embodiment will be omitted in some cases.

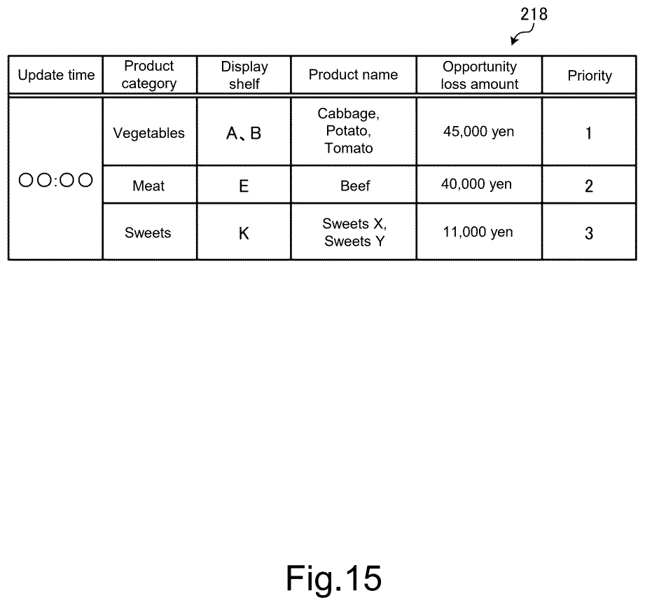

The storage device 21 of the store server 2 includes a stocking information management table 218 shown in FIG. 15. The stocking information management table 218 is a data table for managing a product in short supply for each product category. The product category is for classifying products sold at the store, and can be arbitrarily set by the store. The stocking information management table 218 stores update time, a product category, a display shelf, a product name, an opportunity loss amount, and priority in association with each other.

The update time, the display shelf, and the product name are similar to those in the second embodiment. The product category is information for specifying the product category set by the store. In the case where a product that belongs to one product category is displayed on a plurality of display shelves, the plurality of display shelves is registered corresponding to the one product category. The opportunity loss amount is the sum of the opportunity loss amounts of the products in short supply of the corresponding product category. In the example shown in FIG. 15, the product in short supply whose product category is “vegetables” includes “cabbage”, “potato”, and “tomato”. In this case, the opportunity loss amount is 45,000 yen, which is the sum of 20,000 yen of the opportunity loss amount of the “cabbage”, 15,000 yen of the opportunity loss amount of “potato”, and 10,000 yen of the opportunity loss amount of “tomato” in the product master 212. The priority is priority for each product category, and is set in descending order of the corresponding opportunity loss amount.

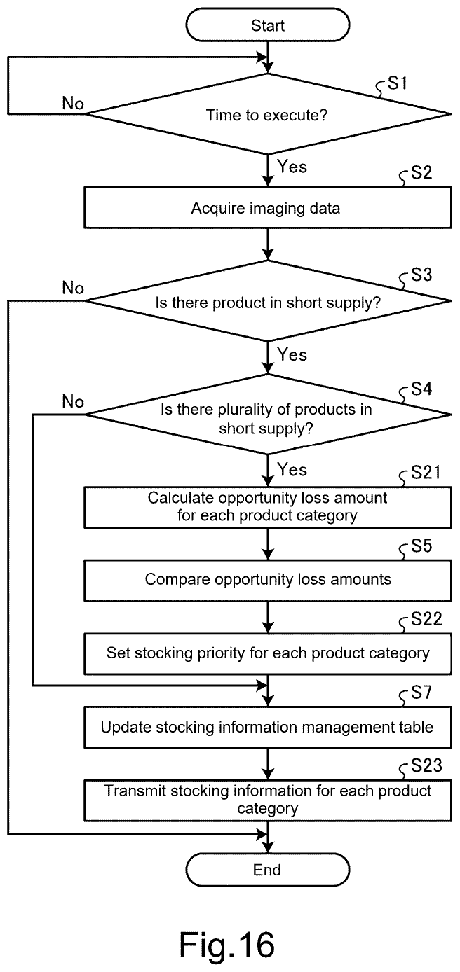

Next, stocking information notification processing executed by the store server 2 will be described. FIG. 16 is a flowchart showing stocking information notification processing performed by the controller 20 of the store server 2 according to the third embodiment.

The processing of Step S1 to Step S4 is similar to that in the second embodiment. In the case where there is a plurality of products in short supply in Step S4 (Yes in Step S4), the processing of the controller 20 proceeds to Step S21. In Step S21, the controller 20 calculates, by the setting means 2005, the opportunity loss amount for each product category. Specifically, in the case where the product in short supply selected by the selection means 2004 includes a plurality of products in one product category, the controller 20 adds, by the setting means 2005, the opportunity loss amounts of the products in short supply that belong to the product category by referring to the product master 212.

Subsequently, in Step S5, the controller 20 compares, by the setting means 2005, the opportunity loss amounts for each product category calculated in Step S21 with each other. Subsequently, in Step S22, the controller 20 sets the stocking priority for each product category. Specifically, the controller 20 sets, by the setting means 2005, the priority in units of a product category in descending order of the opportunity loss amount.

Subsequently, in Step S7, the controller 20 updates the stocking information management table 218. The controller 20 transmits, by the output means 2006, stocking information for each product category to the sales clerk terminal 3. The stocking information for each product category includes classification specification information for specifying the product category to which the product in short supply belongs, the priority in units of a product category, and the product name of the product in short supply. The controller 20 then ends the stocking information notification processing.

Further, in the case where the product in short supply does not include a plurality of products in Step S4 (No in Step S4), the controller 20 skips Step S21, Step S5, and Step S22 to proceed to Step S7.

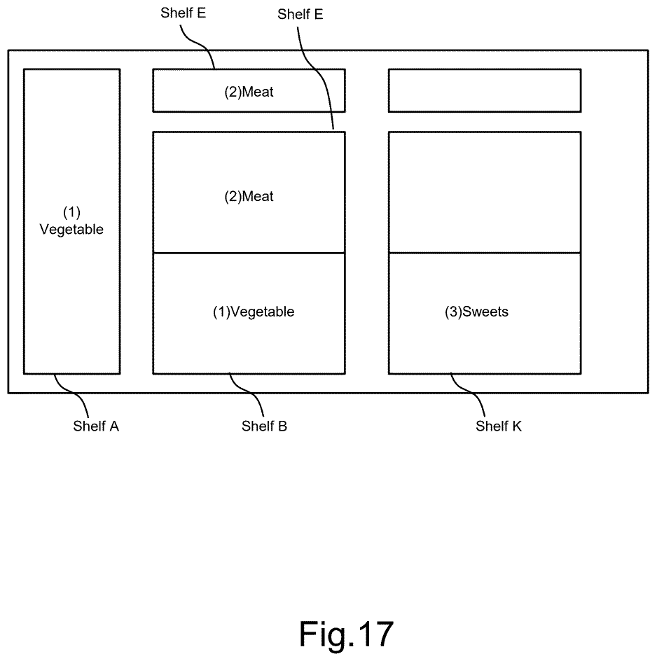

Next, display of stocking information by the sales clerk terminal 3 will be described. FIG. 17 is a diagram showing a stocking information notification screen displayed on the display device 32 of the sales clerk terminal 3 according to the third embodiment. A stocking information notification screen in the case where the stocking information shown in FIG. 15 is registered in the stocking information management table 218 of the store server 2 will be described here as an example.

The display device 32 displays, for a product in short supply, the priority and the product category name for each product category to which the product in short supply belongs, in association with the display shelf. Specifically, the display device 32 displays a map of the sales floor in which the display shelves are grouped by the product category to which the product displayed on the corresponding display shelf belongs. Further, the display device 32 displays the product category to which the product in short supply belongs and the priority in association with the display shelf grouped by the product category. For example, the display device 32 displays the priority “(1)” and the product category name “vegetables” in association with the display shelf (shelf A, shelf B) on which products whose priority is “1”, which belong to the product category “vegetables”, in the stocking information management table 218 shown in FIG. 15 are displayed.

Similarly, the sales clerk terminal 3 displays, for also another product category to which the product in short supply belongs, the priority for each product category and the product category name in association with the display shelf grouped as this product category. Specifically, the display device 32 displays the priority “(2)” and the product category name “meat” in association with the display shelf (shelf E) on which products whose priority is “2”, which belong to the product category “meat”, are displayed. Further, the display device 32 displays the priority “(3)” and the product category name “sweets” in association with the display shelf (shelf K) on which products whose priority is “3”, which belong to the product category “sweets”, are displayed.

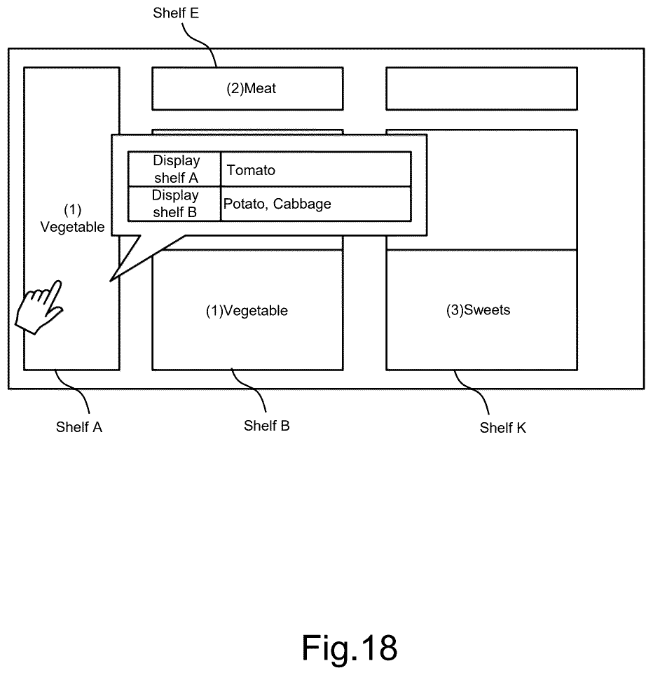

A sales clerk can recognize that the product in short supply that belongs to the product category “vegetables” should be preferentially stocked, by viewing the stocking information notification screen displayed on the display device 32. As shown in FIG. 18, when the sales clerk taps the display shelf portion where “vegetables” is displayed in the stocking information notification screen, the display device 32 displays details of the stocking information in a pop-up. For example, the display device 32 displays the product name of the product in short supply and the display shelf name in a pop-up. As a result, the sales clerk can check the details of the stocking information.

The sales clerk can recognize the priority of the product category to which the product in short supply belongs, i.e., the priority of the product in short supply for each product category, by viewing the stocking information notification screen displayed on the display device 32. The sales clerk can perform stocking in order that is beneficial to the store by recognizing the priority, similarly to the first embodiment and the second embodiment.

Further, since stores preserve products in warehouses for each product category normally, by setting priority of a product in short supply for each product category, the sales clerk can efficiently perform the work when taking out the product in short supply from warehouse. For example, the sales clerk can group products in short supply to be stocked in one stocking operation into one product category, and the workability when taking out the products in short supply from warehouse is improved.

The sales clerk can make, for also the products in short supply that belong to the product categories “meat” and “sweets”, details of the stocking information be displayed in a pop-up, similarly.

As described above, the controller 20 of the store server 2 according to the embodiment functions as the acquisition means 2003, the selection means 2004, the setting means 2005, and the output means 2006. The controller 20 then acquires, by the acquisition means 2003, stock information (imaging data) indicating a stock status of a product displayed on a sales floor. Further, the controller 20 selects, on the basis of the stock information acquired by the acquisition means 2003, a product in short supply that needs to be replenished to the sales floor by the selection means 2004. Further, the controller 20 sets, in the case where the selection means 2004 has selected a plurality of products in short supply, priority of replenishment to the sales floor for the selected product in short supply by the setting means 2005. Further, the controller 20 outputs, by the output means 2006, stocking information in which product specification information for specifying the product in short supply selected by the selection means 2004 and the priority set by the setting means 2005 are associated with each other.

As a result, the store server 2 allows the sales clerk to recognize a product in short supply and stocking priority of the product in short supply. For this reason, the sales clerk can perform stocking in order that is beneficial to the store. As a result, the store server 2 is capable of increasing the contribution to store profits.

Further, the store server 2 according to the embodiment, the controller 20 sets, by the setting means 2005, priority on the basis of the degree of opportunity loss (opportunity loss amount) determined for each product.

As a result, the store server 2 is capable of suppressing the profit reduction due to the loss of sales opportunities caused by generation of a product in short supply in a store.

Further, in the store server 2 according to the embodiment, the controller 20 sets, by the setting means 2005, different priority for each product in short supply.

As a result, the store server 2 is capable of setting the priority of the product in short supply in detail. For this reason, the store server 2 is capable of more effectively suppressing the profit reduction due to the loss of sales opportunities caused by generation of a product in short supply.

In addition, in the store server 2 according to the embodiment, the controller 20 sets, by the setting means 2005, different priority for each product display portion associated with each product. The controller 20 then outputs, by the output means 2006, stocking information that is associated with the priority and includes display portion specification information for specifying the product display portion.

As a result, the store server 2 is capable of causing the sales clerk to recognize the priority for each display shelf. For this reason, since the sales clerk can collectively stock products in short supply for each display shelf, it is possible to efficiently perform the work when stocking products on a display shelf.

Further, in the store server 2 according to the embodiment, the controller 20 sets, by the setting means 2005, different priority for each product category for classifying each product. The controller 20 then outputs, by the output means 2006, stocking information that is associated with the priority and includes classification specification information for specifying the product category.

As a result, the store server 2 is capable of causing the sales clerk to recognize the priority for each product category. For this reason, the sales clerk can efficiently perform the work when taking out the product in short supply from warehouse in one time of stocking.

Note that in the embodiment, the control program to be executed by the devices of the store server 2, the sales clerk terminal 3, the registration terminal 4, and the accounting device 5 may be recorded on a recording medium that can be read by a computer, such as a CD-ROM, and provided. Further, the control program to be executed by each device according to the embodiment may be stored on a computer connected to a network such as the Internet and provided by being downloaded through the network. Further, the control program may be provided through a network such as the Internet.

Although an embodiment has been described, this embodiment is presented as an example and is not intended to limit the scope of the invention. For example, the method of displaying stocking information by the display device 32 of the sales clerk terminal 3 may be realized by a combination of the display methods in the embodiments described above. Further, the stocking information to be output by the store server 2 may include information regarding the number of products to be replenished to the sales floor in association with the product in short supply, for example. In this case, the store server 2 stores the appropriate number of displayed products set for each product in advance, and calculates the number of products to be replenished on the basis of the detected number of displayed products in short supply and the stored appropriate number of products. As a result, the store is capable of replenishing the product in short supply with the appropriate number of products and displaying the appropriate number of products.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method, comprising:
acquiring, by a camera that is mounted on each of a plurality of shopping carts used by customers on a sales floor and directable to the sales floor, imaging data of the sales floor;
acquiring, by a server having a product master file, on a basis of the imaging data acquired by the camera on each of the plurality of shopping carts, stock information indicating a stock status of each of products displayed on the sales floor, the product master file storing product specification information for all products displayed in the sales floor in association with identification information for the multiple product shelves on which each of the products is displayed;
selecting, by the server, on a basis of the acquired stock information, products in short supply that need to be replenished to the sales floor;
setting, by the server, priority of replenishment to the sales floor for the selected products in short supply;
storing, by the server, product specification information and the set priority in a stocking information management table, the product specification information being for specifying the selected products in short supply;
outputting, from the server to a clerk terminal device, stocking information in which the product specification information for specifying the selected products in short supply and the set priority, which are stored in the stocking information management table, are associated with each other;
transmitting, from the server to a clerk terminal device, the product master file updated by the server;
reading, by the clerk terminal device, from the product master file transmitted by the server, the identification information of the product shelf associated with the product specification information included in the outputted stocking information; and
displaying, by the clerk terminal device, a stocking information notification screen that includes a floor map specifying locations of the selected products in short supply on the sales floor, the product specification information of the selected products, and the set priority, on a display of the clerk terminal device, the product identification information and the set priority of the selected product in short supply are displayed on the floor map at a position corresponding to the product shelf of the read identification information.

2. The method according to claim 1, wherein said setting the priority of replenishment comprises setting an order of replenishment by product.

3. The method according to claim 2, wherein said setting the priority of replenishment comprises:
calculating an amount of opportunity loss with respect to each product displayed on the sales floor; and
setting the order of replenishment in a decremental order of the calculated amount of opportunity loss.

4. The method according to claim 1, wherein
the sales floor includes a plurality of product shelves, and at least one of the product shelves includes a plurality of display regions for a plurality of products, and
said setting the priority of replenishment comprises setting an order of replenishment by product shelf.

5. The method according to claim 4, wherein said setting the priority of replenishment comprises:
calculating an amount of opportunity loss with respect to each product shelf on the sales floor; and
setting the order of replenishment in a decremental order of the calculated amount of opportunity loss.

6. The method according to claim 1, wherein
the sales floor includes a plurality of product shelves for a plurality of product categories, and
said setting the priority of replenishment comprises setting an order of replenishment by product category.

7. The method according to claim 6, wherein said setting the priority of replenishment comprises:
calculating an amount of opportunity loss with respect to each product category; and
setting the order of replenishment in a decremental order of the calculated amount of opportunity loss.

8. The method according to claim 1, further comprising:
acquiring, by a code scanner that is mounted on one of the plurality of shopping carts separately from the camara mounted thereon, a product code of a product; and
registering the acquired product code for a transaction.

9. The method according to claim 1, wherein, on each of the plurality of shopping carts used by customers, the camera is mounted on a front end of a basket of the shopping cart.

10. The method according to claim 1, wherein the floor map selectively indicates the selected products in short supply without indicating products in none-short supply.
